(19) United States
(12) Patent Application Publication
(10) Pub. No.: US 2008/0117632 A1
(43) Pub. Date: May 22, 2008

(54) Plate-Shaped Ornamental Light

(76) Inventor: Xuliang Li, Dongguan (CN)

Correspondence Address: GLOBAL IP SERVICES, 7285 W. Eagle Court, Winton, CA, 95388, US

(21) Appl. No.: 11/736,185

(22) Filed: Apr. 17, 2007

(30) Foreign Application Priority Data
Nov. 20, 2006 (CN) 200620015861.8

(51) Int. Cl. F21S 13/14

(52) U.S. Cl. 362/252; 362/84; 362/808

(57) ABSTRACT

The invention relates to an ornamental light, and more particularly, relates to a plate-shaped ornamental light which includes a base plate and a plurality of bulbs mounted thereon. A luminous composite layer including luminous material is formed on the base plate. The luminous composite layer constitutes a pattern. The film stores optical energy when in bright environment and emits light when in dark environment. Thus, the plate-shaped ornamental light can provide decorative effect in dark environment regardless of the lighting of the bulbs, hence, meeting requirement of some particular environment such as Christmas night, Disco club or ghost room for adult games.

### CROSS REFERENCE TO RELATED PATENT APPLICATION

This application claims the priority of the Chinese patent application No. 200620015861.8, Filing date of Nov. 20, 2006.

### FIELD OF THE INVENTION

The invention relates to an ornamental light and, more particularly, to a plate-shaped ornamental light.

### BACKGROUND OF THE INVENTION

Ornamental lights are frequently used in our daily life especially on festivals to create atmosphere. A conventional plate-shaped ornamental light includes a plate on which patterns are painted in advance and a plurality of bulbs mounted on the plate. One feature of this ornamental light is that the decorative effect will be shown only when the bulbs are lighted. And when in dark environment, no decorative effect will be shown without lighting the bulbs. However, in some particular environments, e.g., in Christmas night, in a Disco club or a ghost room for adult games, the present atmosphere will be destructed if all the bulbs are lighted. Thus, conventional ornamental lights fail to meet the requirement of the above environments.

### SUMMARY OF THE INVENTION

A main object of the invention is to provide a plate-shaped ornamental light, which overcomes the drawbacks of the conventional technology and shows decorative effect in dark environment regardless of lighting of the bulbs.

To achieve above object, the invention provides a plate-shaped ornamental light which comprises a base plate and a plurality of bulbs disposed on the base plate. The base plate has a luminous composite layer formed thereon which forms at least one pattern. The luminous composite layer comprises a layer of luminous material. The base plate is a flat plate or curved plate. The luminous composite layer may be formed on one or both sides of the base plate.

Each luminous composite layer has a plurality of bulbs arranged thereon. The bulbs conform to the at least one pattern described above. The plate-shaped ornamental light of the invention may further comprise a support bracket on which the base plate is fixed. In addition, the quantity of the base plate may be more than one, and all of the base plates may be fixed on the support bracket. The profile of each base plate is the same with that of the pattern arrangement on the base plate. The luminous material may be luminous powder or luminous film.

The plate-shaped ornamental light of the invention comprises a base plate and a plurality of bulbs mounted thereon. A luminous composite layer is formed on the base plate. The luminous composite layer constitutes a particular pattern arrangement. Since the bulbs are provided on the base plate, the ornamental light of the invention functions as a conventional ornamental light when the bulbs are lighted. The luminous composite layer includes a layer of luminous material capable of storing optical energy when in bright environment and emitting light when in dark environment. Therefore, the luminous composite layer placed on the plate-shaped ornamental light of the invention may store optical energy when exposed in bright environment or when the bulbs are lighted, and may emit light when in dark environment. Thus, the plate-shaped ornamental light of the invention can provide decorative effect in dark environment regardless of the lighting of the bulbs, hence, meeting requirement of some particular environment such as in Christmas night, in a Disco club or a ghost room for adult games.

### BRIEF DESCRIPTION OF THE DRAWINGS

FIG. 1 is a schematic view of a first embodiment of the invention;

FIG. 2 is a right side view of FIG. 1;

FIG. 3 is a partially enlarged view of portion A of FIG. 2;

FIG. 4 is a schematic view of a second embodiment of the invention;

FIG. 5 is a cross-sectional view of FIG. 4 along B-B line.

### DETAILED DESCRIPTION OF ILLUSTRATED EMBODIMENTS

Various embodiments of the invention will be described now in conjunction with the drawings.

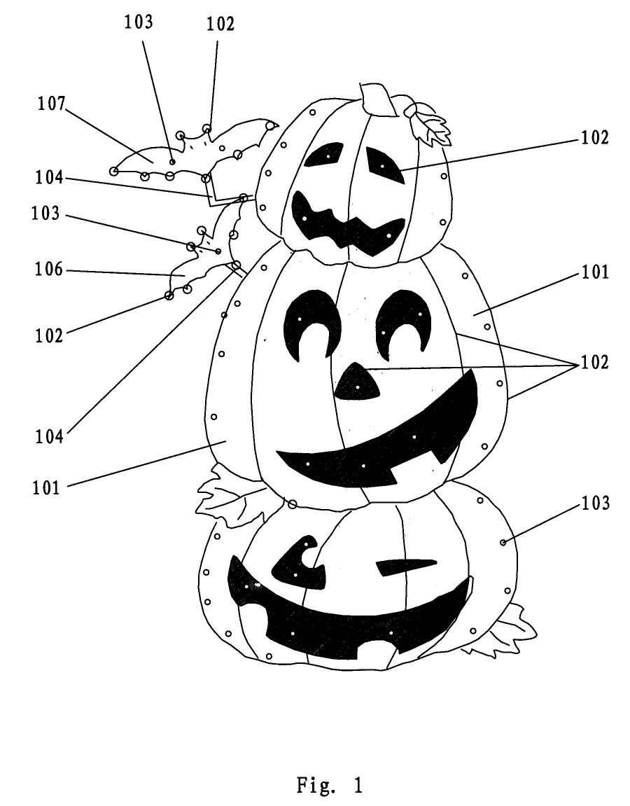

FIGS. 1-3 illustrate a first exemplary embodiment of the present invention.

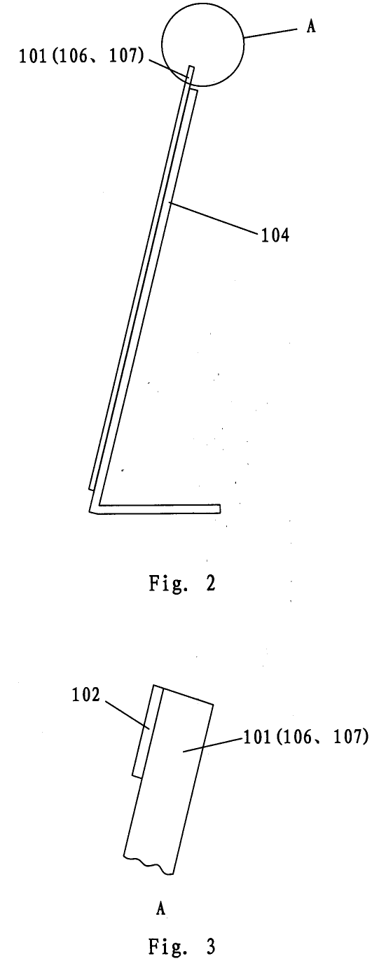

Referring to FIG. 1, a plate-shaped ornamental light according to a first embodiment includes three base plates, i.e., a primary base plate 101 and two secondary base plates 106 and 107. Three pumpkin patterns are downwardly and sequentially painted on a top side of the primary base plate 101. Each pumpkin pattern includes a pair of eyes and a mouth. The secondary base plates 106, 107 are located on top left portion of the primary base plate 101. A pattern of flying bat is painted on a top side of each secondary base plate 106 and 107. The profile of the primary base plate 101 conforms to the profiles of the pumpkin patterns. The profiles of the secondary base plates 106 and 107 conform to those of the bat patterns respectively. A support bracket 104 is disposed on a bottom side of the base plates. The primary base plate 101 and the secondary base plates 106, 107 are fixed on the support bracket 104 via screw bolts. Referring to FIG. 2, the support bracket 104 of the embodiment can enhance the structure stiffness of the ornamental light and moreover, can make the entire ornamental light erect upon the ground. The primary base plate 101 and the secondary base plates 106, 107 each have several bulbs 103 attached thereon. Referring to FIG. 3, a luminous composite layer 102, which constitutes the patterns described above, is covered on the top side of the primary base plate 101 and the secondary base plates 106, 107. The luminous composite layer 102 comprises a luminous film and an adhesive layer sandwiched between the base plates and the luminous film. The primary base plate 101 and the secondary base plates 106 and 107 each may be a flat plate. The plurality of bulbs 103, which forms the patterns described above, is mounted on the luminous composite layer 102. Referring to FIG. 1, the plurality of bulbs 103 collectively forms the patterns of pumpkins and bats. As shown in the figure, the bulbs 103 located on marginal regions of the base plates are clearly shown. Besides the marginal regions, other regions of the base plates are also provided with the bulbs 103 (not completely shown), and these bulbs conform to the luminous composite layer 102. The bulbs 103 are connected to a power supply via wires and switches.

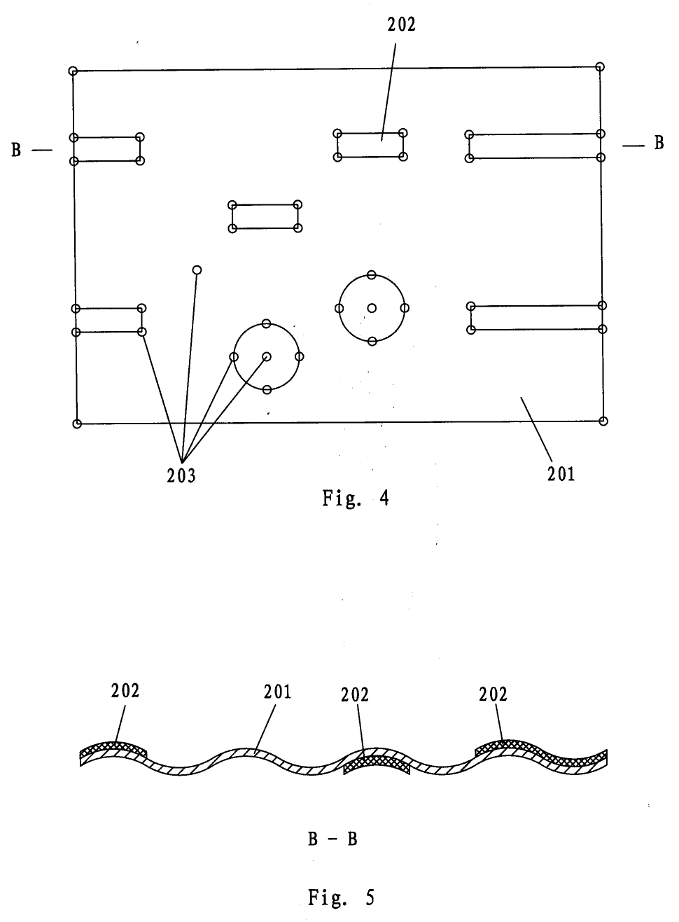

FIGS. 4-5 illustrate a second embodiment of the invention.

The plate-shaped ornamental light of the embodiment may be used in Disco club. Referring to FIGS. 4-5, a plate-shaped ornamental light comprises a waved base plate 201, on both sides of which a plurality of bulbs 203 is disposed. A luminous composite layer 202, which forms a decorative pattern, is covered on the both sides of the waved base plate 201. The luminous composite layer 202 comprises a luminous film and an adhesive layer. A plurality of bulbs 202 is disposed on the luminous composite layer 202 to form a certain pattern. The portions of the base plate, on which no luminous composite layer is covered, may also have several bulbs 203 mounted thereon to bring decorative effect. The bulbs 203 connect to a power supply through wires and switches.

1. A plate-shaped ornamental light, comprising:
a base plate with a profile of a pattern;
a luminous composite layer is covered on said base plate to form the pattern, and said luminous composite layer comprises a layer of luminous material.
said luminous composite layer has a plurality of bulbs arranged thereon, and the bulbs conform to said pattern.

2. The plate-shaped ornamental light according to claim 1, wherein said base plate is a flat plate.

3. The plate-shaped ornamental light according to claim 1, wherein said base plate is a curved plate.

4. The plate-shaped ornamental light according to claims 1, wherein said luminous composite layer is formed on one side of the base plate.

5. (canceled)

6. (canceled)

7. The plate-shaped ornamental light according to claims 1, wherein said luminous composite layer is formed on the both sides of said base plate.

8. (canceled)

9. (canceled)

10. (canceled)

11. The plate-shaped ornamental light according to claim 1, wherein further comprising a support bracket on which said base plate is fixed.

12. The plate-shaped ornamental light according to claim 11, wherein the quantity of the base plate is more than one, and the entire base plates are fixed on said support bracket.

13. (canceled)

14. (canceled)

15. (canceled)

16. The plate-shaped ornamental light according to claim 1, wherein said luminous material is a luminous powder or a luminous film.
